(19) United States
(12) Patent Application Publication
(10) Pub. No.: US 2011/0283063 A1
(43) Pub. Date: Nov. 17, 2011

(54) DISK ARRAY DEVICE, A DISK ARRAY DEVICE CONTROL METHOD AND A DISK ARRAY DEVICE CONTROL PROGRAM

(76) Inventor: MASUMI TAKIYANAGI, Tokyo (JP)

(21) Appl. No.: 13/103,896

(22) Filed: May 9, 2011

(30) Foreign Application Priority Data
May 11, 2010 (JP) 109140/2010

(51) Int. Cl. G06F 12/08

(52) U.S. Cl. 711/114; 711/E12.019

(57) ABSTRACT

A disk array device includes a control unit which sends and receives a command and data to/from a host device, and in case a first disk device which constitutes RAID is stopped, controls so that data which is to be written from the host device to the stopped first disk device is written to a second disk device different from the first disk device.

### INCORPORATION BY REFERENCE

This application is based upon and claims the benefit of priority from Japanese Patent Application No. 2010-109140, filed on May 11, 2010, the disclosure of which is incorporated herein in its entirety by reference.

### TECHNICAL FIELD

The present invention relates to a disk array device and in particular, relates to control of a disk device used in a disk array device.

### BACKGROUND ART

In recent years, with the increase of data in a computer system, use of a disk array (Disk Array) device which constitutes RAID (RAID: Redundant Arrays of Inexpensive (Independent) Disks) is increasing. Such a disk array device splits a plurality of disk devices into a predetermined components (hereinafter, referred to as a rank (rank)).

Also, in various computer systems, it is requested to reduce electric power consumption. In particular, with the increase of data in recent years, storage devices used for each computer system is growing. As a result, reduction in electric power consumption of a storage device becomes necessary.

A disk array device is also one of storage devices and it is required to reduce the electric power consumption. Therefore, technologies which reduce electric power consumption of each component such as a control unit and a disk device which constitute a disk array device have been developed.

Further, a control unit of a disk array device or an external management device can manage disk devices or ranks built in the disk array device individually. Therefore, the control unit of the disk array device controls the disk devices and the ranks, improves their operation, and reduces the electric power consumption.

For example, a disk array device includes many disk devices. However, those disk devices and ranks composed of disk devices are not used evenly. Accordingly, the disk array device monitors loads of the disk devices, and stops a power supply of the disk device with low load (for example, refer to patent document 1).

As one of such technologies which stops a disk device which is not used or whose frequency of use is low and suppresses electric power consumption, there exits MAID (Massive Array of Inactive (Idle) Disks) technology.

In MAID technology, frequency that an input/output command from a host device is received is different among ranks of the disk array device. Further, in general, ranks which frequently receive access from the host device are certain limited ranks out of the whole ranks, and for many other ranks, frequency which receives an input/output command is low. In other words, access to ranks of a disk array device concentrates in its part and is distributed unevenly in many cases.

MAID assumes such uneven distribution characteristic of an input/output command for ranks. And MAID stops a part of or whole of the disk devices of the rank for which an input/output command is not issued or expected not to be issued, and suppresses the electric power consumption.

In this MAID, as for a direction which stops disk devices, there is a case in which a host device which issues input/output commands directs and there is another case in which a disk array device determines by own device based on a frequency of input/output commands from a host device.

In case a host device directs, before issuing an input/output command to a rank including stopped disk devices, the host device directs start of the stopped disk devices and issues the input/output command after the stopped disk device are started. As a result, the disk array device which received the input/output command processes input/output for a normal rank. Therefore, the host device can assume a response time of a normal command.

On the other hand, in case of a disk array device which stops disk devices based on the frequency of input/output commands from a host device like a disk array device described in patent document 1, the host device does not know the rank in which the disk device are stopped. Therefore, there is a case the host device may issue an input/output command to the rank in which disk device are stopped. In this case, the disk array device processes the received input/output command of the host device after the disk devices of the rank which became a target of the command are started. In this case, the disk array device requires a long time until completion of the input/output command.

That is, the disk array device described in patent document 1 has a problem which generates delay in a response to a host device, and in the worst case, causes processing of the host device to time out.

Further, in case there is a plurality of host devices, even if a disk array device stops disk devices based on a direction from a certain host device, other host devices do not know the stopped disk devices. Therefore, a disk array device which is connected with a plurality of host devices generates, even when disk devices is stopped by directions from a host device, delay in processing time same as a case in which own device judges and stops.

As its countermeasure, there is a disk array device using a reduced state of a rank. For example, in case the disk array device judges by own device and stops disk devices of a predetermined rank, the disk array device selects the disk devices to be stopped as it becomes in the same state as a reduced state of RAID of the rank. To describe specifically, for example, in case the rank of target constitutes RAID1 composed of two units of disk devices, the disk array device stops a disk device on one side and sets it in the same state as a reduced state of RAID1. Also in case a rank of target constitutes RAID3 composed of five units of disk devices, for example, the disk array device stops a disk device storing parity and sets it in the same state as a reduced state of RAID3.

Thus, in case the disk array device receives the read command when the disk device is stopped in the same state as the reduced state, the disk array device can read data from a starting (active) disk device and respond to the host device. Thus, in case a predetermined rank is set to a stopped state of disk devices equal to a reduced state, even if data is not read from the stopped disk device, the disk array device can respond to the read command.

However, in case the disk device receives a write command, the disk array device cannot respond with a stopped state of a disk device equal to such a reduced state. This is because, when the disk array device completes operation of the write command in the reduced state, it becomes writing of data in a state of low reliability. Therefore, in case the write command is received, the disk array device starts the stopped disk device and writes data. However, in case processing is done after a disk device is started, as has been already described, there is a problem that a response time of the disk array device to the host device becomes long.

Accordingly, the disk array device is used which stores write data in a memory such as a buffer of the disk array device until stopped disk device starts (for example, refer to patent documents 2 and 3). In other words, the disk array device which receives the write command while the disk device is stopped stores data to be written to the disk device in the memory such as buffer of the disk array device until the stopped disk device starts. And after the stopped disk device starts, the disk array device writes the data stored in the memory to the disk device. In other words, the disk array device described in patent documents 2 or 3 uses the same processing as processing of write back for the write command to the stopped disk device.

[The Preceding Technical Literature]

[Patent Document]

[Patent document 1] Japanese Patent Application Laid-Open No. 2002-297320

[Patent document 2] Japanese Patent Application Laid-Open No. 2009-163310

[Patent document 3] Japanese Patent Application Laid-Open No. 2009-187450

However, the buffer of the disk array device is provided for use as a cache in normal read or write processing.

Also, semiconductor memory used for the buffer and so on is more expensive per capacity compared with a magnetic disk used for the disk device. Therefore, a general disk array device does not include a memory such as buffer with the capacity comparable to a built-in disk device.

In other words, the capacity of the buffer of the disk array device is enough to store data which was accessed to a disk device in starting, though, it is not so large that data of a plurality of write commands can be stored while the disk device is stopped.

Therefore, in case the write command to the stopped disk device is received, it becomes necessary for the disk array device which stopped the disk device to start the stopped disk device always, and to write back data stored in the cache to the disk device.

Thus, in the disk array device described in patent documents 2 or 3 mentioned above, in case the write command to a rank including the stopped disk device is received, there was a problem that the disk device has to be started always.

### SUMMARY

An exemplary object of the present invention is to solve the problems mentioned above, and to provide a disk array device, a disk array device control method and a disk array device control program which can, even in case a write command to a rank in a power saving mode is received, respond without starting a stopped disk device.

A disk array device according to an exemplary aspect of the present invention: includes a control unit which sends and receives a command and data to/from a host device; and in case a first disk device which constitutes RAID is stopped, controls so that the data which is to be written from the host device to the stopped first disk device is written to a second disk device different from the first disk device.

A disk array device control method according to an exemplary aspect of the present invention includes: sending and receiving a command and data to/from a host device; controlling a first disk device which constitutes RAID and a second disk device different from the first disk device; and in case the first disk device is stopped, writing the data which is to be written from the host device to the stopped first disk device to the second disk device.

A computer readable medium embodying a control program causing a disk array device to perform a method according to an exemplary aspect of the present invention is a control program of a disk array device characterized by making a computer execute: processing which sends and receives a command and data to/from a host device; processing which controls a first disk device which constitutes RAID and a second disk device different from the first disk; processing which manages a configuration of the first disk device and the second disk device; and processing which, in case the first disk device is stopped, writes the data which is to be written from the host device to the stopped first disk device to the second disk device.

### BRIEF DESCRIPTION OF THE DRAWINGS

Exemplary features and advantages of the present invention will become apparent from the following detailed description when taken with the accompanying drawings in which:

FIG. 1 is a block diagram showing one example of a configuration of a disk array device according to the first exemplary embodiment of the present invention.

FIG. 2 is a figure showing one example of a configuration of a history storage unit according to the first exemplary embodiment.

FIG. 3 is a figure showing one example of a stored data table according to the first exemplary embodiment.

FIG. 4 is a flow chart showing one example of read operation of a normal mode according to the first exemplary embodiment.

FIG. 5 is a flow chart showing one example of read operation of a normal mode according to the first exemplary embodiment.

FIG. 6 is a flow chart showing one example of operation which transitions to a power saving mode according to the judgment of own device according to the first exemplary embodiment.

FIG. 7 is a flow chart showing one example of operation which transitions to a power saving mode according to the host device directions according to the first exemplary embodiment.

FIG. 8 is a flow chart showing one example of read operation at a time of power saving according to the first exemplary embodiment.

FIG. 9 is a flow chart showing one example of write operation at a time of power saving according to the first exemplary embodiment.

FIG. 10 is a flow chart showing one example of write back operation to a rank according to the first exemplary embodiment.

FIG. 11 is a flow chart showing one example of write back operation to a rank according to the first exemplary embodiment.

FIG. 12 is a block diagram showing one example of other configuration of a disk array device according to the first exemplary embodiment.

FIG. 13 is a block diagram showing one example of other configuration of a disk array device according to the first exemplary embodiment.

FIG. 14 is a flow chart showing one example of read operation at a time of power saving according to the second exemplary embodiment.

FIG. 15 is a flow chart showing one example of write back operation to a rank according to the third exemplary embodiment.

### EXEMPLARY EMBODIMENT

Next, the exemplary embodiment of the present invention will be described with reference to drawings.

Further, for convenience of description, in the following, a state of a rank that a power supply of a certain part of a disk device of the rank is stopped same as a reduced state is called “power saving mode”. A state of a rank that a power supply of all disk devices of the rank is on and in operation is called “normal mode”. Also, unless described otherwise, initial mode of each rank is made a normal mode.

### The First Exemplary Embodiment

Next, the first exemplary embodiment of the present invention will be described in detail with reference to drawings.

First, a configuration of disk array device 1 according to the first exemplary embodiment will be described.

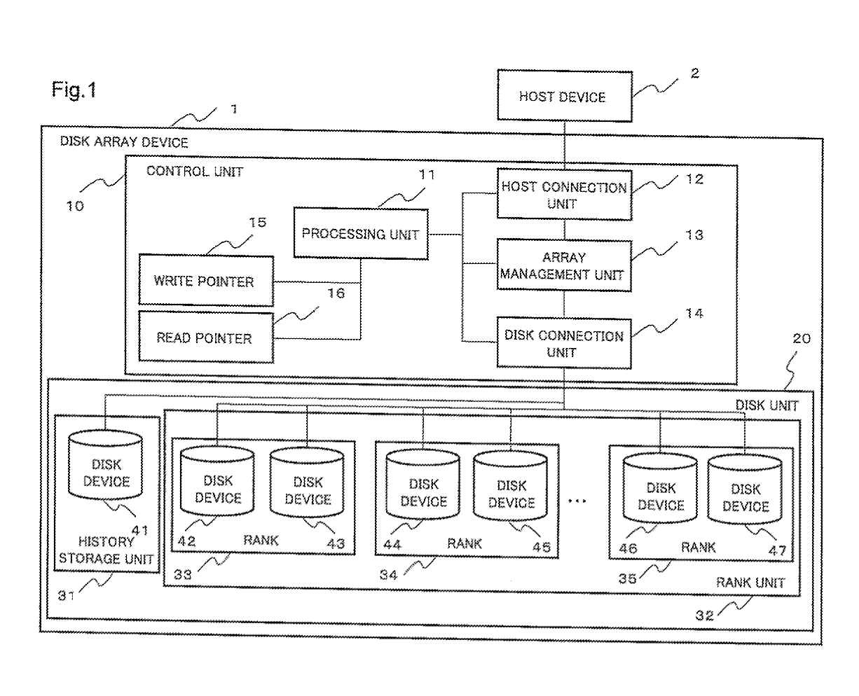

FIG. 1 is a block diagram showing one example of a configuration of a disk array device 1 according to the first exemplary embodiment of the present invention.

The disk array device 1 connects with a host device 2 which is a general computer or a server via a general network, for example, a fiber channel, and receives write commands or read commands from the host device 2 and exchanges data with the host device 2. Further, although the host device 2 is shown in FIG. 1 as one unit, this is for convenience of description to the end. The disk array device 1 may connect with a plurality of units of host devices 2 via a network. Also, in FIG. 1, although the disk array device 1 is also shown as one unit, this is also for convenience of description. No smaller than two units of disk array devices 1 may connect with the host device 2 via a network.

The disk array device 1 according to the first exemplary embodiment includes disk unit 20 including a plurality of units of disk device 41 to disk device 47 (hereinafter, put together and referred to as a disk device group) and control unit 10 which controls exchange of data with the host device 2 by controlling the disk unit 20. The disk unit 20 includes first disk devices (disk device 42 to disk device 47) which constitutes a RAID (RAID: Redundant Arrays of Inexpensive (Independent) Disks) and a second disk device (disk device 41) which constitutes a history storage unit 31.

The control unit 10 includes a processing unit 11, a host connection unit 12, an array management unit 13, a disk connection unit 14, a write pointer 15, and a read pointer 16.

The processing unit 11 includes, for example, a microprocessor and a memory, controls each unit included in the control unit 10, exchanges commands with the host device 2 via the host connection unit 12, and controls commands of the disk unit 20 via the disk connection unit 14. Moreover, the processing unit 11 also processes the write pointer 15 and the read pointer 16 which are used in a power saving mode described in detail later. Further, in FIG. 1, although the write pointer 15 and the read pointer 16 are shown as an independent block, this is for convenience of description to the end. The write pointer 15 and the read pointer 16 may be stored inside the processing unit 11, or may be stored in a disk device group of the disk unit 20.

The host connection unit 12 processes a connection with the host device 2 following directions of the processing unit 11. When described more specifically, the host connection unit 12 performs signal processing and a message exchange along a predetermined protocol (protocol: communication procedure) of a network; receives commands from the host device 2 and notifies the processing unit 11; and returns a message from the processing unit 11 including command completion to the host device 2. Also, the host connection unit 12 forwards data received from the host device 2 to the array management unit 13 and returns data received from the array management unit 13 to the host device 2.

The array management unit 13 manages the disk unit 20 via the disk connection unit 14 logically following a direction of the processing unit 11. This logical management includes management of a configuration of the history storage unit 31 and the rank unit 32, a rank configuration of the rank 33 to the rank 35 (hereinafter, referred to as a rank group) in the rank unit 32 and a RAID configuration of the disk device group in the rank group. Also, the array management unit 13, based on a RAID configuration and in case necessary, generates parity data when writing and synthesizes data when reading.

When described specifically, it becomes as follows. In case of receiving the read command from the host device 2, the array management unit 13 reads data from disk devices corresponding to a striping (striping: distribution) of RAID configuration directed by the processing part 11 via the disk connection unit 14. After synthesizing data of the array management unit 13, returns data to the host device 2 via the host connection unit 12. On the other hand, in case of receiving the write command, the array management unit 13 writes data received via the host connection unit 12 to disk devices corresponding to a striping of RAID configuration directed by the processing part 11 via the disk connection unit 14. In this case, the array management unit 13 generates and stores necessary data including parity. Further, although described in detail later, the array management unit 13 manages read operation and write operation in power saving mode from the disk device 41 included in the history storage unit 31 and the disk device 42 to the disk device 47 included in the rank unit 32 (hereinafter, referred to as a disk device for rank).

The disk connection unit 14 interfaces, following a direction from the processing unit 11, issuing of commands (for example, read or write) and receiving of messages for the disk device group, and exchanging of data between the disk device group and the array management unit 13.

The disk unit 20 includes the disk device group. Further, as has been already described, the disk unit 20 is, based on management of the array management unit 13, logically divided into and composed of the history storage unit 31 and the rank unit 32 including the rank group which constitutes RAID. As an example, the rank unit 32 shown in FIG. 1 includes the rank 33 of the disk device 42 and the disk device 43, the rank 34 of the disk device 44 and the disk device 45, and the rank 35 of the disk device 46 and the disk device 47.

Further, the configuration of the history storage unit 31 and the rank unit 32 is an example shown for convenience of description to the end. It is not limited to this and may also be another configuration. Also, a configuration of the history storage unit 31 and the rank unit 32 is a logical configuration which the array management unit 13 sets, the array management unit 13 can change these configurations either statically or dynamically based on a direction from the processing unit 11. However, for convenience of description, the configuration in the following description will be described as fixed.

The history storage unit 31, in a power saving mode which will be describe in detail later, stores write data and regenerates data in write back operation. Further, in FIG. 1, although the history storage unit 31 is composed of one unit of the disk device 41, this is also for convenience of description to the end. The history storage unit 31 may include a plurality of units of disk devices and may constitute RAID using disk devices same as the rank unit 32.

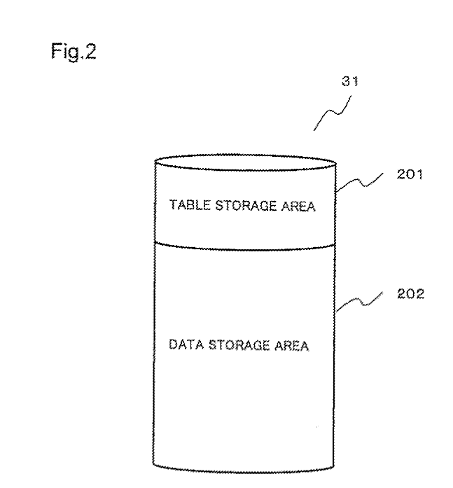

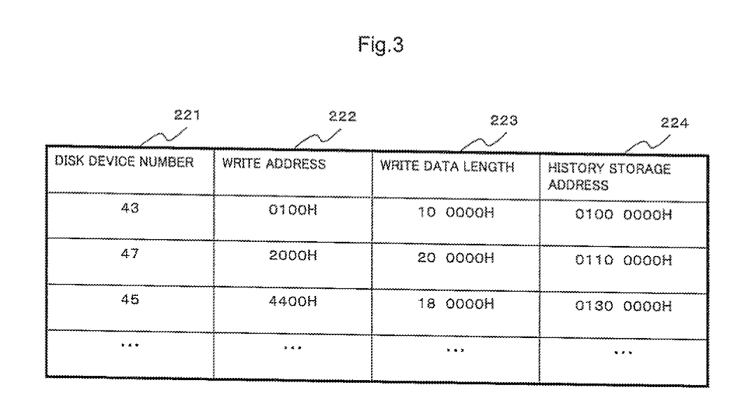

The history storage unit 31 will be described more in detail with reference to FIG. 2 and FIG. 3.

FIG. 2 is a figure showing one example of a configuration of the history storage unit 31.

The history storage unit 31 stores history information of data stored in the first disk device, and includes table storage area 201 and data storage area 202.

The data storage area 202 stores, for example, data which is to be stored in the first disk device which stops in the time of a power saving mode.

The table storage area 201 includes “stored data table” which stores management information of data written in the data storage area 202 of the history storage unit 31 in the time of a power saving mode. The stored data table can be made of various data configurations. The stored data table according to the first exemplary embodiment includes, as an example, various data shown in FIG. 3.

FIG. 3 is a figure showing one example of a stored data table. Further, “H” of FIG. 3 shows hexadecimal notation.

The stored data table according to the first exemplary embodiment includes disk device number 221, write address 222, write data length 223, and history storage address 224.

The disk device number 221 stores the number of a disk device in which the data stored in history storage unit 31 should be stored primarily. Further, the disk device number 221 needs only to be data for specifying the disk device, it does not needs to be the number of the disk device necessarily, and, for example, may also be a drive name of the disk device or an address of the disk device.

The write address 222 stores the write start address of the disk device indicated by the disk device number 221 in which data stored in history storage unit 31 is to be stored primarily. The write data length 223 stores the length of data stored in the history storage unit 31. In other words, the data stored in the history storage unit 31 is the data which is received the direction: to write data from the address stored in the write address 222 for the length indicated in the write data length 223 to the disk device indicated in disk device number 221. For example, the data indicated in the first row of FIG. 3 shows the data that are written in addresses from 0100H for the length of 100000H to, and the data are stored the disk device with the disk device number of “43”.

The history storage address 224 stores the write start address of data written in the data storage area 202 of the history storage unit 31. In other words, the data stored in the history storage unit 31 is written from the address indicated in the history storage address 224 for the length of the data indicated in the write data length 223.

Further, in this exemplary embodiment, although the history storage unit 31 is assumed to be one unit of the disk device 41, this is for convenience of description to the end. As has been already described, the history storage unit 31 may include a plurality of units of disk devices. In this case, the disk array device 1 stores also the number of disk device of the history storage unit 31 which is used to store the data in the stored data table.

The data storage area 202 is an area in which data shown in the stored data table is written actually. For example, the data of the first row of FIG. 3 is written from address 01000000H indicated in the history storage address 224 of the data storage area 202 for the data length of 100000H indicated in the write data length 223, in other words, to 010FFFFFH.

Returning to FIG. 1, the description of the disk array device 1 is continued.

The rank unit 32, whose configuration is controlled by the array management unit 13, includes a rank preparing a RAID configuration using a plurality of disk devices for rank. Further, although rank unit 32 shown in FIG. 1 includes three ranks for convenience of description, the ranks included in the rank unit 32 are not limited to three, and may be two and less or four or more.

The rank 33 to rank 35 (rank group) are ranks of a RAID (RAID) configuration composed of disk devices for ranks. The configuration of ranks is controlled by the array management unit 13. Further, although each rank includes two units of disk devices in FIG. 1, this is also for convenience of description to the end, and each rank may include three units of disk devices or more respectively and independently.

Also, as has been already described, the configuration of the history storage unit 31, the rank unit 32, and the rank group in the rank unit 32 is set logically based on management of the array management unit 13.

Accordingly, in the disk array device 1 of FIG. 1, although the disk device 41 is included in the history storage unit 31 and the disk device for ranks is included in one rank respectively, it is not limited to this. One disk device may be included in a plurality of ranks or included in the history storage unit 31 and one or more rank. Further, the disk array device 1 may not be limited to one unit of disk device is included in the history storage unit 31 and rank unit 32 and it may be that a plurality of units of disk devices may be included in the history storage unit 31 and the rank unit 32.

The disk device 41 to disk device 47 (disk device group) constitute the history storage unit 31 or the rank unit 32 based on management of the array management unit 13, store data received from the host device 2 via the disk connection unit 14, and reproduce data to be returned to the host device 2. Also, in case a power saving mode which will be describe later is released, there is also a case the disk device 41 included in the history storage unit 31 and disk devices for rank included in the rank unit 32 exchange data.

Further, the disk device group may be a general magnetic disk device, or may be a disk device including a magnetic disk device and peripheral circuit such as a cache. Also, the disk device group is not limited to a magnetic disk device. For example, the disk device group may be optical-magnetic disc devices, devices composed of a disk which can record and reproduce data or also semiconductor memory devices which don't have physical disks.

Next, operation of disk array device 1 according to the first exemplary embodiment will be described with reference to drawings.

Further, in the following description, although each rank is described as a configuration of RAID1 using two units of disk devices, this is for convenience of description to the end. The exemplary embodiment of the present invention may be RAID1 of three units or more, or needless to say, may also be other RAID configurations. Also, in the first exemplary embodiment, because there are no differences in the operation among ranks, unless described otherwise, a rank of specific description target is described with reference to the rank 33 composed of the disk device 42 and the disk device 43.

Further, as has been already described, because the processing unit 11 controls each unit of the disk array device 1, a description of the operation below will be mainly described based on operation of the processing unit 11.

Further, as for a configuration of array for the array management unit 13, it is assumed that an external manager device not shown or the host device 2 directs the processing part 11 in advance, and the processing unit 11 which received the direction directs the array management unit 13. Therefore, a description of a setup of an array configuration and so on will be omitted.

First, operation for a read command in normal mode will be described with reference to drawings.

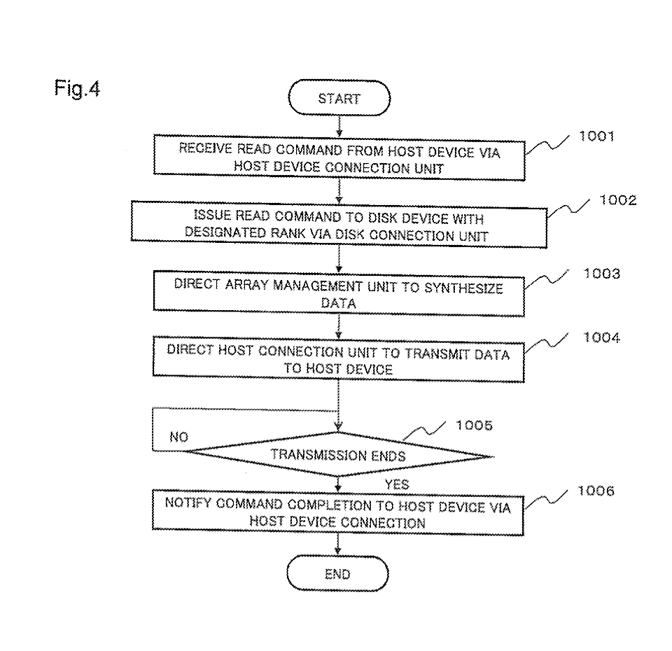

FIG. 4 is a flow chart showing one example of operation of a read command in normal mode of the disk array device 1 according to the first exemplary embodiment.

First, the processing unit 11 receives a read command from the host device 2 via the host connection unit 12 (Step 1001).

The processing unit 11 which judged that the received command is a read command distinguishes a rank directed by the command, and directs disk devices (disk device 42 and disk device 43) corresponding to the rank (rank 33) designated by the command to read data via disk connection unit 14 (Step 1002).

The processing unit 11 directs the array management unit 13 to synthesize data of the rank (rank 33) following directions to disk devices of the rank (Step 1003). Based on this direction, the array management unit 13 receives the data from disk devices (disk device 42 and disk device 43) which constitutes the rank (rank 33) via disk connection unit 14, synthesizes data, and transmits it to the host connection unit 12.

Further, the processing unit 11 directs the host connection unit 12 to transmit data to host device 2 (Step 1004). The host connection unit 12 which received this direction starts the transmission of synthesized data received from the array management unit 13 to host device 2 after detecting that the host device 2 is in a state possible to receive.

After starting transmission of data, the processing unit 11 waits for completion of the transmission of data (Step 1005). As the confirmation of the completion of this transmission, the disk array device 1 can utilize various processing. For example, the processing unit 11 may monitor the data transmission processing of the host connection unit 12, or the host connection unit 12 may also notify processing unit 11 when data transmission ends.

When the transmission of data ends, the processing unit 11 directs the host connection unit 12 to notify the host device 2 of command completion (Step 1006). The host connection unit 12 transmits the command completion to the host device 2, and processing of a read command of the disk array device 1 for the host device 2 ends. The processing unit 11 performs predetermined completion processing as needed, for example, stops operation of each unit or clears a memory used for data transmission which is not shown.

Further, in a description of this exemplary embodiment, although the processing unit 11 directs disk devices included in a rank, a part other than processing unit 11 may perform direction to the disk device. For example, the array management unit 13 may perform not only synthesis of data but also direction to a disk device.

Next, the operation of a write command in the normal mode will be described with reference to drawings.

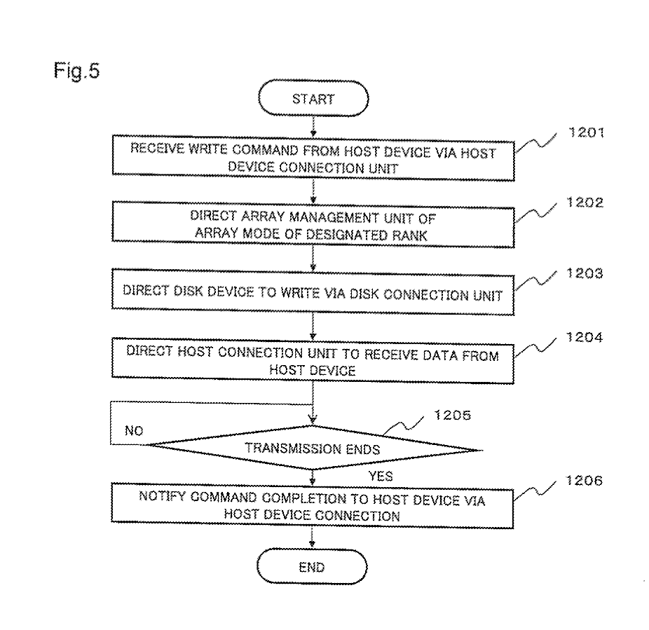

FIG. 5 is a flow chart showing one example of operation of a write command in the normal mode of the disk array device 1 according to the first exemplary embodiment.

The processing unit 11 receives a write command from the host device 2 via the host connection unit 12 (Step 1201).

The processing unit 11 which judged that the received command is a write command directs the array management unit 13 to write with striping to the disk devices (disk device 42 and disk device 43) of the rank (rank 33) directed by the command (Step 1202).

Next, the processing unit 11 directs the disk devices (disk device 42 and disk device 43) corresponding to the rank (rank 33) directed by the command to write data via the disk connection unit 14 (Step 1203).

The processing unit 11 notifies the host device 2 of the effect that reception of data becomes possible via the host connection unit 12 after the write direction to the disk devices ends (Step 1204). The host device 2 which received this notice transmits data to be written in the disk array device 1. The disk array device 1 transmits the data received from the host device 2 to the disk devices (disk device 42 and disk device 43) via the host connection unit 12, the array management unit 13, and the disk connection unit 14, and stores it. Further, in case of the configuration such as RAID3 which needs parity, the array management unit 13 generates parity data based on received data from the host device 2 and stores them in the disk device.

When reception of data starts, the processing unit 11 waits for completion of the data reception from the host device 2 (Step 1205). The disk array device 1 can also utilize various processing for a confirmation of completion of this data reception. For example, the processing unit 11 may monitor reception processing via the host connection unit 12, or the host connection unit 12 may also notify the processing unit 11 corresponding to completion of data reception.

When reception of data ends, the processing unit 11 directs the host connection unit 12 to notify command completion of the host device 2 (Step 1206). Further, in order to accelerate response to the host device 2, the processing unit 11 of this exemplary embodiment notifies the host device 2 of completion when data reception by the host connection unit 12 ends. The host connection unit 12 transmits the command completion to the host device 2, and the processing of a write command for the host device 2 ends. However, the processing in disk array device 1 still remains. After all received data is written to the disk devices (disk device 42 and disk device 43), the processing unit 11 performs predetermined completion processing as needed, for example, stops each unit.

Further, same as a read command, also in a write command, the direction to the disk devices is not limited to the processing unit 11. For example, the array management unit 13 may perform the direction to the disk devices.

Next, operation of shift processing to the power saving mode of the disk array device 1 will be described with reference to drawings.

First, operation in which the disk array device 1 judges by own device and shifts to a power saving mode when there is no access from the host device 2 to ranks for a predetermined time, will be described.

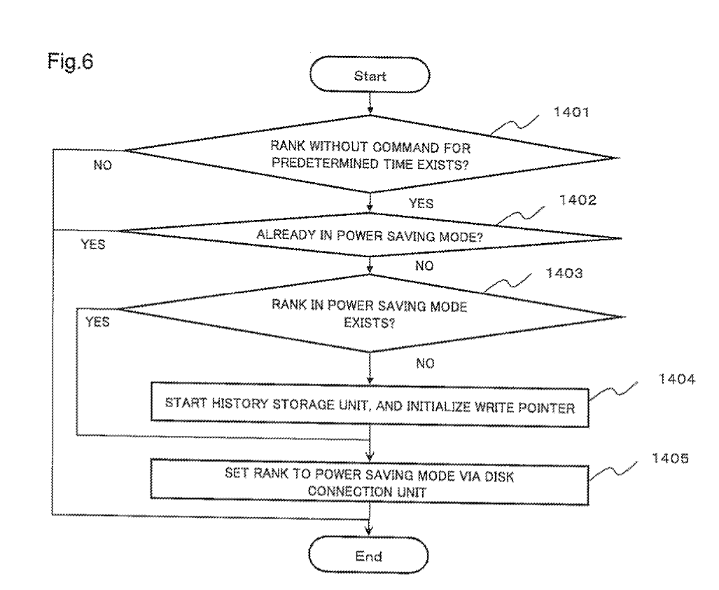

FIG. 6 is a flow chart showing one example of operation in which the disk array device 1 according to the first exemplary embodiment judges by own device and shifts to a power saving mode.

The processing unit 11 monitors access state from the host device 2 to rank groups. And, in case a rank which has no access from the host device 2 for more than a predetermined time is detected, the processing unit 11 starts processing which shifts the rank to the power saving mode (yes in Step 1401).

First, the processing unit 11 distinguishes whether the rank already shifted to the power saving mode (Step 1402). In case it is already in the power saving mode (yes in Step 1402), because there is no need for processing in particular, the processing unit 11 ends shift processing. Further, according to this exemplary embodiment, the processing unit 11 stores a mode of the rank (power saving mode or normal mode). In other words, the processing unit 11 stores modes of all ranks in the initial state as a normal mode, changes the mode of the rank which shifted to the power saving mode to the power saving mode and stores it. However, a place which stores a mode of a rank group is not limited to the processing unit 11, and other configurations including the array management unit 13 may store it and the processing unit 11 may read it.

In case the rank of target is not in the power saving mode (no in Step 1402), the processing unit 11 distinguishes whether there is a rank other than the rank of target which already becomes the power saving mode (Step 1403). In case there is no other rank which is in the power saving mode (no in Step 1403), the processing unit 11 starts the disk device 41 of the history storage unit 31 and initializes a stored data table of the table storage area 201 (Step 1404). Further, in case there is no rank which is in the power saving mode, the disk array device 1 according to the first exemplary embodiment stops the disk device 41 of the history storage unit 31 and reduces electric power consumption. Therefore, the processing unit 11 performs judgment of Step 1403 and processing of Step 1404. However, in case it is predicted that the power saving mode occurs in most cases and stopping the disk device 41 of the history storage unit 31 is not needed, the processing unit 11 does not stop the disk device 41, and may omit processing of Step 1403 and Step 1404.

When starting of the history storage unit 31 ends, the processing unit 11 makes the disk devices (disk device 42 and disk device 43) of the rank of target (rank 33) shift to the power saving mode similar to reduction (Step 1405). If this processing is described more specifically, it becomes as follows. The rank 33 constitutes RAID1 with the disk device 42 and the disk device 43. Therefore, the processing unit 11 makes one of disk device 42 or disk device 43 into a stopped state similar to reduction, via the disk connection unit 14. In a description of this exemplary embodiment, the description is continued assuming that the disk device 43 is stopped.

Next, shift processing to the power saving mode in case a direction is received from the host device 2 will be described.

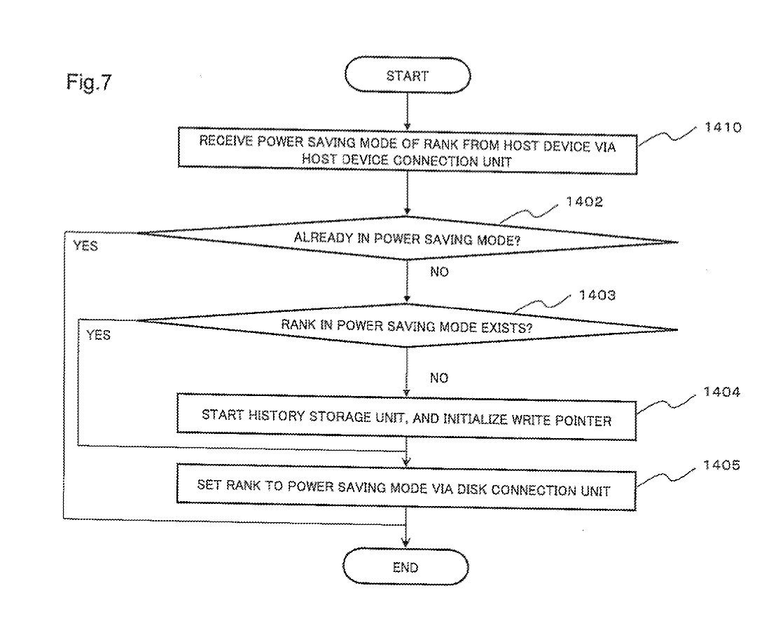

FIG. 7 is a flow chart showing one example of operation in which the disk array device 1 according to the first exemplary embodiment shifts to the power saving mode following a direction from the host device 2.

Also in case the disk array device 1 receives a direction from the host device 2, operation of the processing unit 11 will be, except for certain operation, the same operation as a case in which the disk array device 1 distinguishes by own device. Therefore, in FIG. 7, same number will be assigned to the same operation as in FIG. 6, a detailed description will be omitted, and different operation is described in detail.

The processing unit 11 which received a direction of the power saving mode from the host device 2 via the host connection unit 12 (Step 1410) distinguishes whether the directed rank is already in the power saving mode (Step 1402). Because the operations of Step 1402 and after about the processing unit 11 are same as operations described with reference to FIG. 6, a detailed description of operations thereafter will be omitted.

Next, operation for a read command in the power saving mode will be described.

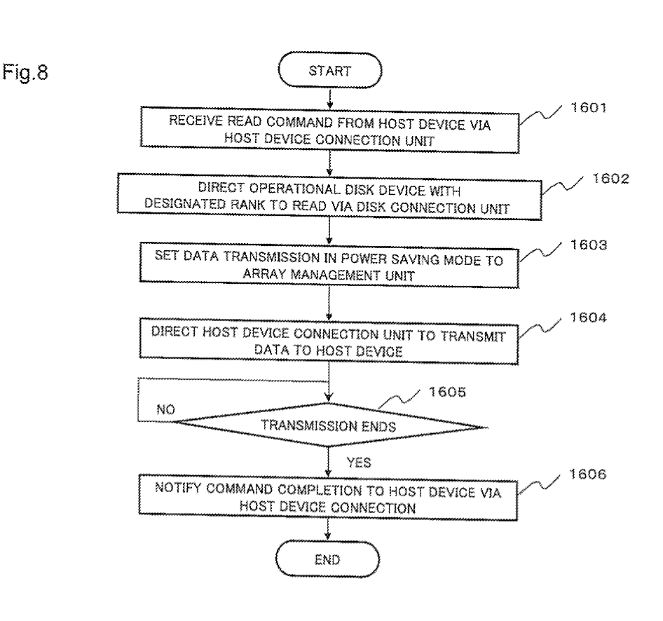

FIG. 8 is a flow chart showing one example of read operation in the power saving mode of the disk array device 1 according to the first exemplary embodiment.

First, the processing unit 11 receives a read command from the host device 2 via the host connection unit 12 (Step 1601).

The processing unit 11 which judged that the received command is a read command distinguishes a rank directed by the command and directs a disk device corresponding to the rank to read the data via the disk connection unit 14. However, in case the processing unit 11 confirms a mode of the rank of target, and the rank is the power saving mode similar to reduced state, it directs the operational (active) disk device (disk device 42) to read (Step 1602). And, in case of the power saving mode, the processing units 11 does not perform anything to a stopped disk device (disk device 43).

Following the direction to the disk device to read, the processing unit 11 directs the array management unit 13 to read data in the power saving mode (Step 1603). If this operation is described more specifically, it becomes as follows. For example, when the rank is RAID1, the array management unit 13 receives data from the active disk device (disk device 42), does not access a stopped disk device (disk device 43), and transmits the data to the host connection unit 12 without synthesizing. Also, for example, in case the rank is RAID3 and so on and the disk device for parity is stopped, the array management unit 13 transmits the data read from disk devices to host connection unit 12 without performing generation and confirmation of parity.

Further, the processing unit 11 directs the host connection unit 12 to transmit data to the host device 2 (Step 1604). Based on this direction, the host connection unit 12 starts transmitting the data received from the array management unit 13 to the host device 2.

When transmission operation of data to the host device 2 starts, the processing unit 11 waits for completion of the transmission operation (Step 1605). As has been already described, the disk array device 1 can utilize various processing also for the confirmation of completion of this transmission.

After completion of transmission of data, the processing unit 11 directs the host connection unit 12 to notify the host device 2 of command completion (Step 1606). The host connection unit 12 transmits the command completion to the host device 2, and the processing of read command ends. The processing unit 11 performs predetermined completion processing as needed.

Further, also in the power saving mode, not only processing unit 11 but other configurations, for example, the array management unit 13 may directs a disk device included in a rank.

Thus, the disk array device 1 according to the first exemplary embodiment can respond to a read command without starting a stopped disk device in the power saving mode.

Next, operation for a write command in the power saving mode will be described with reference to drawings.

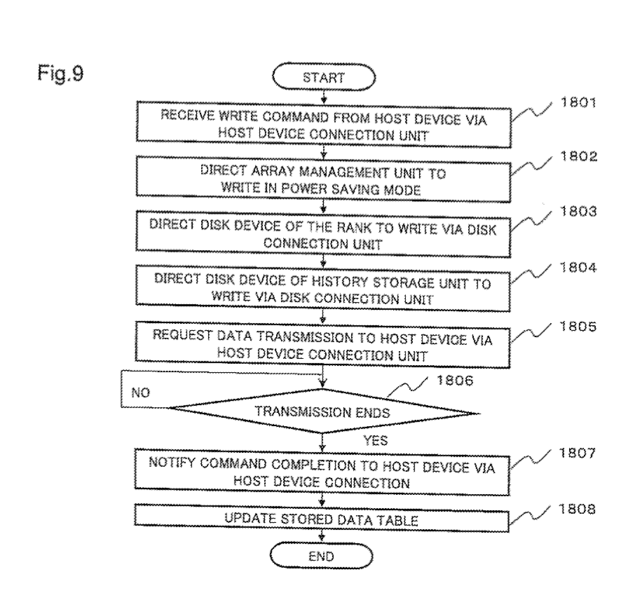

FIG. 9 is a flow chart showing one example of write operation in the power saving mode of the disk array device 1 according to the first exemplary embodiment.

The processing unit 11 receives a write command from the host device 2 (Step 1801).

The processing unit 11 which judged that the received command is a write command directs the array management unit 13 to write in the power saving mode in case the rank of target is in the power saving mode (Step 1802). If described specifically, the processing unit 11 directs to the array management unit 13 a write configuration (RAID configuration) of the power saving mode composed of the active disk device (disk device 42) of the directed rank (rank 33) and the disk device (disk device 41) of the history storage unit 31.

Next, the processing unit 11 directs the active disk device (disk device 42) of the directed rank (rank 33) to write data via the disk connection unit 14 (Step 1803). The processing unit 11 does not perform anything to the stopped disk device (disk device 43).

Further, the processing, unit 11 directs also the disk device 41 of the history storage unit 31 to write data via the disk connection unit 14 (Step 1804). The processing of this direction to the disk device 41 of the history storage unit 31 will become as follows when more detailed operation is described.

The processing unit 11 confirms the stored data table of the table storage area 201 of the history storage unit 31, and confirms the area which can be written next. In this case, the processing unit 11 confirms capacity of data to be stored in the history storage unit 31 based on the write command, and confirms whether the necessary storage capacity can be secured in the data storage area 202. In case the capacity is not enough, the processing unit 11 performs processing which writes back the data of the history storage unit 31 to the rank group, which will be described later, and obtains the capacity of the history storage unit 31.

Further, in a description of this exemplary embodiment, although it is described that the data stored in the history storage unit 31 is stored as one group for convenience of description, the present invention is not limited to this. For example, the processing unit 11 may store data to be stored separated in a plurality of areas using a pointer about link data, or may store it in a random position using the same mechanism as FAT (File Allocation Table) used by an operating system of a computer too.

After preparation of the disk devices (disk device 41 and disk device 42) and the array management unit 13 are completed, the processing unit 11 notifies the host device 2 that reception of data becomes possible via the host connection unit 12 (Step 1805). The host device 2 which received this notice transmits data to be written to the disk array device 1. The disk array device 1 transmits data received from the host device 2 to each disk device (disk device 41 and disk device 42) via the host connection unit 12, the array management unit 13, and the disk connection unit 14, and stores it. Further, in case of a RAID configuration which generates and stores parity data such as RAID3, the array management unit 13 generates parity data based on data received from the host device 2 and stores it in a predetermined disk device.

After data reception starts, the processing unit 11 waits for completion of the data reception from the host device 2 (Step 1806). As has already been described, the disk array device 1 can use various processing also for confirmation of this data reception completion.

When reception of data ends, the processing unit 11 directs the host connection unit 12 to notify the host device 2 of command completion (Step 1807). The host connection unit 12 transmits the command completion to the host device 2 and the processing of a write command of the host device 2 ends.

After storing of received data in the disk device 41 and the disk device 42 ends, the processing unit 11 updates the stored data table of the history storage unit 31 based on information of stored data (Step 1807). After that, the processing unit 11 performs other completion processing as needed and ends the processing.

Further, also in a write command in the power saving mode, directions to disk devices is not limited to the processing unit 11. For example, the array management unit 13 may direct disk devices.

Thus, the disk array device 1 according to the first exemplary embodiment does not start a stopped disk device of the rank and can respond to a write command from host device 2 in the power saving mode too.

Next, in case write data of the history storage unit 31 exceeds a predetermined threshold value, the disk array device 1 distinguishes by own device and performs operation which writes back data of the history storage unit 31 to disk devices of the rank designated by the command of the host device 2. This operation will be described with reference to drawings.

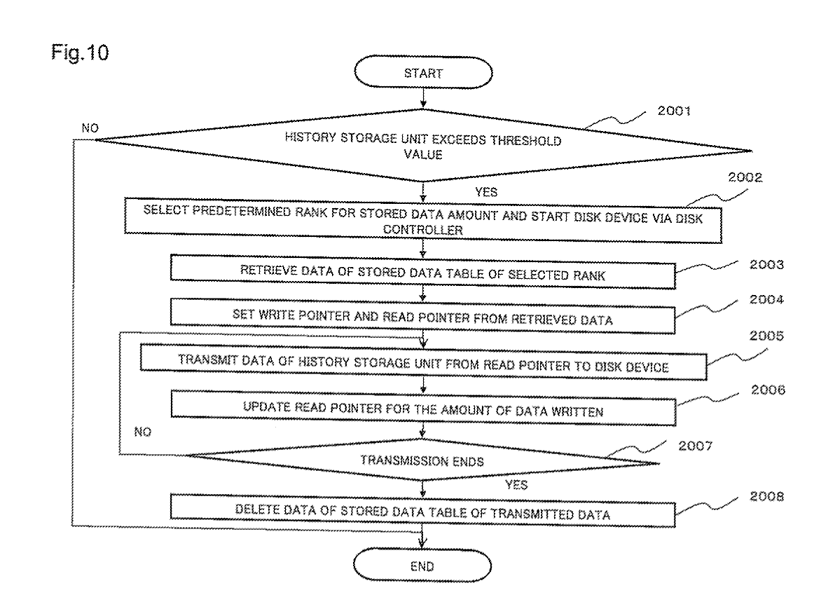

FIG. 10 is a flow chart showing one example of operation which writes back data of the history storage unit 31 of the disk array device 1 according to the first exemplary embodiment to disk devices of a predetermined rank.

The processing unit 11 determines whether the data storage capacity of disk device 41 of the history storage unit 31 exceeded a predetermined threshold value (Step 2001). When the threshold value is not exceeded (no in Step 2001), the processing unit 11 ends without performing processing in particular. Further, it is assumed that this threshold value is, for example, set in the processing unit 11 based on the capacity of the history storage unit 31 or obtained by processing unit 11 with calculation (for example, 90% of the capacity of the history storage unit 31) in advance, and a detailed description about setting of the threshold value will be omitted. Also, concerning the confirmation of the data storage capacity of the history storage unit 31 which processing unit 11 according to this exemplary embodiment performs, it is assumed that the processing unit 11 confirms periodically with a predetermined cycle or confirms when writing to history storage unit 31, a detailed description of starting of confirmation will be omitted.

In case the capacity of the data which already stored in the history storage unit 31 exceeds the threshold value (yes in Step 2001), the processing unit 11 checks the stored data table, selects a rank which writes back data by a predetermined method, and starts a stopped disk device of the rank selected via the disk connection unit 14 (Step 2002). Further, as a method to select a rank to write back, the processing unit 11 can use various methods. For example, the processing unit 11 may select a rank whose data stored in disk device 41 is greatest, or may use LRU (Least Recently Used) used by a cache. In a description of this exemplary embodiment, the description is made with the rank of target to be the rank 33 same as the former description.

After starting the selected disk device of a rank for write back, the processing unit 11 retrieves data which is written back to the stopped disk device (disk device 43) of the rank of target (rank 33) by referring to a stored data table (Step 2003). In a description of this exemplary embodiment, a description is made by assuming that the data of the first row which FIG. 3 shows was selected. After retrieving data, the processing unit 11 sets the write back address (0100H) to the disk device (disk device 43) of the rank of target (rank 33) to the write pointer 15 and sets the read out address (0100 0000H) from the disk device 41 of the history storage unit 31 to read pointer 16 from the data retrieved (Step 2004).

After setting pointers, the processing unit 11 reads data from the address of the disk device 41 of the history storage unit 31 indicated by the read pointer 16 and writes back data to the address of the disk device 43 of the rank 33 designated in the write pointer 15 (Step 2005). After writing data, the processing unit 11 updates the read pointer 16 and the write pointer 15 for the amount of data which it moved (Step 2006). For example, in case 100H of data is moved, processing unit 11 sets 0200H to the write pointer 15 and sets 0100 0100H to the read pointer 16.

The processing unit 11 determines whether write back of data is completed by referring to the stored data table (Step 2007). If an example of this confirmation is described specifically, it becomes as follows. Because the write address of the data of the first row in FIG. 3 is 0100H, and the data length is 100000H, the processing unit 11 judges whether the write pointer 15 is 100100H which is next to the last data of the data to write back. In case it is not yet completed (no in Step 2007), the processing unit 11 returns to Step 2005 and continues transmission of data.

In case transmission of data ends (yes in Step 2007), the processing unit 11 deletes transmitted data (in the present case, first row in FIG. 3) from the stored data table and ends processing (Step 2008).

Further, in a description of this exemplary embodiment up to here, although data to write back is set to one, this exemplary embodiment is not limited to this. After write back of data described above ends, the processing unit 11 confirms whether data of the same rank is registered in the stored data table, and in case data of the same rank is registered, it may repeat the same operation as operation from Step 2004 and write back data. By repeating such write back operation, the processing unit 11 can write back all the data of the selected rank registered in the stored data table.

Next, operation which the disk array device 1 writes back data of the history storage unit 31 to an original rank based by the direction of the host device 2 will be described.

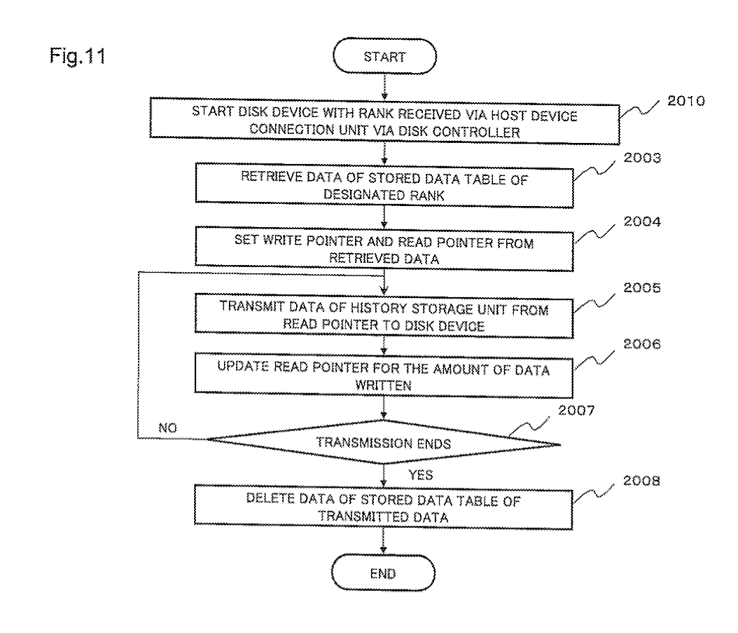

FIG. 11 is a flow chart showing one example of operation in which the disk array device 1 according to the first exemplary embodiment writes back data of the history storage unit 31 to a rank based on a direction of the host device 2.

Also in case a direction is received from the host device 2, because operation of the processing unit 11 will become mostly similar operation as a case in which it distinguishes by own device, in FIG. 11, same number will be assigned to the same operation as in FIG. 10, a detailed description will be omitted, and different operation is described.

The processing unit 11 which received a command of restart of a rank from the host device 2 via the host connection unit 12 starts a stopped disk device of the designated rank. Because operation of the processing unit 11 after this will be the same operation as Step 2003 and after of FIG. 10 when “selected rank” in FIG. 10 is replaced by “designated rank”, detailed description will be omitted.

And, in write back operation according to a command from the host device 2, in case a plurality of directed ranks are registered in the stored data table, the processing unit 11 may write back all registered data.

Reduction in electric power consumption of the disk array device 1 which operates like this will be further described.

A rank which becomes a target of storage in the history storage unit 31 is, as has already been described, the rank whose access frequency from the host device 2 is low. Therefore, it is possible to presume that the amount of data of a rank for which necessity to store in the history storage unit 31 arises is to be small. Accordingly, even if a disk device of the same capacity as a disk device used for a rank with low access frequency is used, the disk device 41 of the history storage unit 31 can store data of a plurality of ranks.

Also, in case access from the host device 2 is reading or updating of data, the capacity of data to be stored in the history storage unit 31 does not increase. Therefore, in the disk array device 1, necessity to write back data stored in the history storage unit 31 to a rank of the power saving mode does not occur, or necessity to start a stopped disk device does not occur either. In contrast, because writing data, in particular, adding data increases the stored data amount in the history storage unit 31, the disk array device 1 needs to start a disk device to write back, and amount of reduction in electric power consumption will be less. Accordingly, as the worst case of reduction about electric power consumption, reduction in electric power consumption in case all the accesses from the host device 2 are addition will be described.

Here, for convenience of description, the following assumption will further be made and a description is made.

a) Each disk device has the same capacity (V [bytes]) and the same electric power consumption (E [W]).

b) Each rank is RAID1 composed of two units of disk devices. In other words, the storage capacity of each rank is the same capacity as one unit of disk device (V [bytes]). Also, because of RAID1, in each rank at the time of the power saving mode, one unit of disk device is active (in operation), and the other unit of disk device stops the operation. In other words, the electric power consumption of the rank in the normal mode will be 2*E, the electric power consumption of the rank in the power saving mode will be 1*E, and the power saving mode can reduce the electric power consumption by the amount of one unit of disk device (E [W]).

c) 5 ranks are assumed to be a rank of target of the power saving mode, and the access frequency of the target rank is assumed to be the same. Its writing rate is assumed to be R [bytes/s]. The access frequency to each rank is assumed to be 1/20 of the maximum transfer rate. In other words, maximum transfer rate Rmax is assumed to be Rmax [bytes/s]=20*R [bytes/s].

d) For convenience of description, influence of other processing is ignored.

e) The history storage unit 31 stores write data of ranks of target in one unit of the disk device 41. In other words, the capacity of the history storage unit 31 is assumed to be V [bytes].

f) Because the capacity of the table storage area 201 of the history storage unit 31 is small compared with the data storage area 202, it is ignored. In other words, it is assumed that the history storage unit 31 can use up to the capacity V [bytes].

g) Write back starts at the time when the history storage unit 31 becomes equal to the maximum capacity. Also it is assumed that write back is performed for each rank and write back is done to all of 5 ranks. In other words, during write back, it is assumed that, among 5 ranks, 4 ranks are in the power saving mode and 1 rank is in the normal mode.

h) Although addition to the rank in write back (in the normal mode) is possible to write to the rank in normal mode because access is low frequency, it is assumed in this description that it is written in the history storage unit 31 as the worst case.

Average reduction in electric power consumption of the disk array device 1 under this assumption will be calculated.

Because the history storage unit 31 responds to 5 ranks, and each rank has the same access frequency, the history storage unit 31 will store data from 5 ranks, in other words, data at 5*R.

Accordingly, time T1 [s] from the time when the disk array device 1 makes 5 ranks to the power saving mode, in other words, stops one unit of disk device each, and starts the disk device 41 of the history storage unit 31, to the time when the history storage unit 31 stores data to the maximum capacity becomes as follows.

T1=V/(5*R)

When the history storage unit 31 reaches the maximum capacity, the disk array device 1 starts write back to each rank. During this write back, the rank of target of write back is in the normal mode, in other words, two units of disk devices are in starting. Further, it is assumed that this write back is performed at a maximum transfer rate. Accordingly, write back time T2 to one rank becomes as follows.

T2=(V/5)/Rmax=(V/5)/(20*R)=T1/20

Because the history storage unit 31 writes back concerning 5 ranks, total time of write back T3 becomes as follows.

T3=T2*5=T1/4=V/(20*R)

The volume of data D [bytes] which is added to the history storage unit 31 during this write back becomes, totaling 5 ranks, as follows.

D=T3*(5*R)=V/4

After write back, while data is collected in the history storage unit 31 from the capacity D [bytes] added during write back to the maximum capacity V [bytes], 5 ranks of target will be in the power saving mode as the start. If time T4 until next write back occurs is calculated, it becomes as follows.

T4=(V−D)/(5*R)=V/(5*R)−D/(5*R)=(3/4)*T1

And, after this T4 elapses, the history storage unit 31 becomes equals to the maximum capacity and again the disk array device 1 writes back for the time of T3. Following this, the disk array device 1 will repeat the power saving mode of 5 ranks for T4 and write back for T3.

To summarize the result, it becomes as follows.

(1) Normal mode until the power saving mode starts
Two units of disk devices each in 5 ranks are in operation (active), and the disk device 41 of the history storage unit 31 stops the operation.
Electric power consumption=5*2*E=10*E [W]

(2) From start of the power saving mode to T1 (period=T1)
The disk device 41 of the history storage unit 31 and one unit of disk device of each rank are in operation (active), and one unit of disk device of each rank stops the operation.
Electric power consumption=E+5*E=6*E [W]
Reduced electric power consumption=10*E−6*E=4*E [W]

(3) From T1 to T1+T3 (period=T3=T1*1/4)
The disk device 41 of the history storage unit 31, two units of disk devices of the rank in write back and each one unit of disk device of other ranks are in operation (active), and each one unit of disk device of other ranks stop the operations.
Electric power consumption=E+2*E+4*E=7*E [W]
Reduced electric power consumption=10*E−7*E=3*E [W]

(4) From T1+T3 to T1+T3+T4 (period: T4=T1*3/4)
The disk device 41 of the history storage unit 31 and one unit of disk device of each rank are in operation (active), and one unit of disk device of each rank stops the operation.
Electric power consumption=E+5*E=6*E [W]
Reduced electric power consumption=10*E−6*E=4*E [W]

(5) After T1+T3+T4
Repeat (3) and (4).

In other words, as for reduction in electric power consumption in the long-run, compared to reduction period of reduced power of 3E [W], period of reduced power of 4E [W] will continue three times longer, and this will be repeated. If average reduction in electric power consumption Esave of this case is calculated, it becomes as follows.

Esave=(3*E*1+4*E*3)/(1+3)=3.75*E[W]

In other words, in case of the assumption assumed here, when long operation is considered, the disk array device 1 can reduce 3.75*E on the average, in other words, electric power consumption of disk devices more than three units.

Thus, even in case access from the host device 2 is addition, the disk array device 1 according to the first exemplary embodiment can reduce electric power consumption.

Further, as has been already described, in case access from the host device 2 is not addition but read, update or delete, the capacity of the data stored in the history storage unit 31 does not increase. Therefore, in case access from the host device 2 other than addition is received, necessity for write back does not occur and the disk array device 1 can continue the power saving mode which reduces power consumption further longer. In other words, the ratio of (4) described above becomes even larger, and the amount of reduction in the electric power consumption increases further.

Thus, the disk array device 1 according to the first exemplary embodiment can respond to a write command without starting a stopped disk device of a rank. Further, even if write back becomes necessary, the disk array device 1 can write back data with a disk device of a part of ranks is in operation, in other words, keeping electric power consumption reducing.

Also, to repeat, although RAID1 is being used in a description according to this exemplary embodiment, the present invention is not limited to this. The disk array device 1 according to this exemplary embodiment may be used for other RAID configurations which includes a reduced state which can stop a disk.

Further, although each configuration of the disk array device 1 according to this exemplary embodiment has been described as an independent block, this is for convenience of description to the end and is not limited to this.

For example, the disk array device 1 may make the control unit 10 include CPU (Central Processing Unit: central processing unit) and a memory, and make each unit such as the processing unit 11 and the array management unit 13 into a program which is performed by the CPU. Also, the disk array device 1 may make the write pointer 15 and the read pointer 16 into data on a memory which CPU uses. Further, the disk array device 1 may include the processing unit 11 not as an independent configuration, but in other configurations, for example, in the array management unit 13. Further, the disk array device 1 may include a storage medium including a program.

On the contrary, the disk array device 1 according to this exemplary embodiment can be composed such that each configuration of the disk array device 1 is a different device.

For example, the disk array device 1 may make the control unit 10 and the disk unit 20 of the disk array device 1 into different devices connected via a network. And, the disk array device 1 may make the control unit 10 and a part of the disk unit 20 (for example, the history possibility unit 31) into one device and the remaining configuration (for example, the rank unit 32) into a different device. Further, the disk array device 1 according to this exemplary embodiment may be divided into and composed of not two devices but of three or more devices. For example, the disk array device 1 according to this exemplary embodiment may make the rank unit 32 not into one configuration, but such that a part of ranks is included in the disk array device 1 and the other ranks are composed of one, two or more external devices.

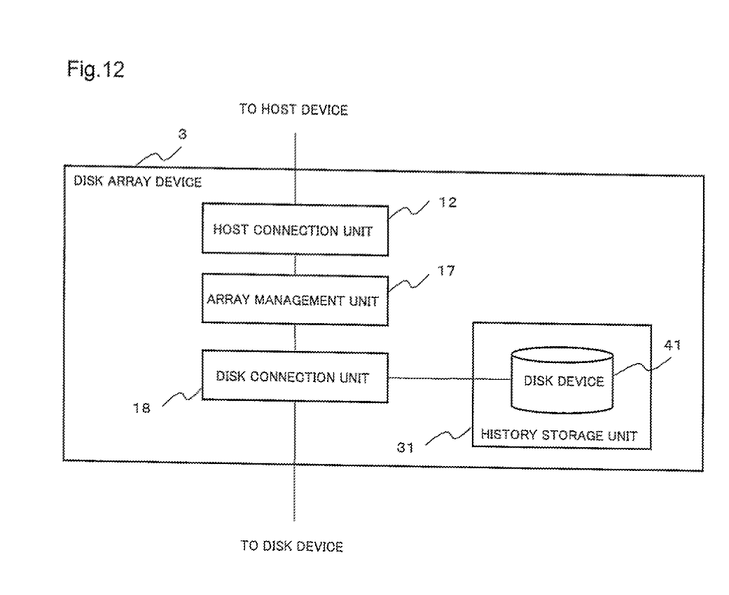

FIG. 12 is a block diagram showing one example of a configuration of disk array device 3 according to the first exemplary embodiment which made a part of the disk unit 20, the rank unit 32 specifically, into different configuration which is not shown. Further, in FIG. 12, same configurations are appended the same numbers as in FIG. 1 and a detailed description will be omitted.

The disk array device 3 makes the rank unit 32 into a different device, and includes the host connection unit 12, the array management unit 17, the disk connection unit 18, and the history storage unit 31 corresponding to the control unit 10 of the disk array device 1.

The host connection unit 12 operates same as the host connection unit 12 according to the first exemplary embodiment.

The array management unit 17 includes, for example, CPU and a memory, which are not shown, built in, and in addition to the same operation as the array management unit 13 of the disk array device 1, performs control operation of each unit same as the processing unit 11. Further, because the array management unit 17 realizes the write pointer 15 and the read pointer 16 using an internal memory which is not shown, in FIG. 12, each pointer is also omitted.

The disk connection unit 18 connects the disk device 41 of the history storage unit 31 and each disk device of the rank unit 32 which is not shown same as the disk connection unit 14 of the disk array device 1 and interfaces data. In the disk array device 1, connection of a disk device and the disk connection unit 18 is connected via a network of a fiber channel using an optical fiber. Because the network of the fiber channel can also connect hundreds or more of meters of distance, the disk connection unit 18 can connect, even if the rank unit 32 is made into a different device, same as the disk connection unit 14 of the disk array device 1. Though, in the disk array device 1, because the disk device 41 of the history storage unit 31 and disk devices for rank of the rank unit 32 are included in the same device, the disk connection unit 14 connected the history storage unit 31 and the rank unit 32 via the same network. However, in the disk array device 3, because the history storage unit 31 and the rank unit 32 are made into different devices, the disk connection unit 18 may connect the history storage unit 31 and the rank unit 32 with different networks.

Further, a network used for the present invention is not limited to a fiber channel. For example, even in case an IP (Internet Protocol) is used, the disk connection unit 14 and the disk connection unit 18 can operate similarly using a predetermined network protocol.

Thus, even if the rank unit 32 of the disk unit 20 is made into a different device, the disk array device 3 can perform the power saving mode using the history storage unit 31 based on the same operation as the disk array device 1 which has already been described.

Further, the disk array device 3 according to this exemplary embodiment may make the disk unit 20 including the history storage unit 31 into a different device.

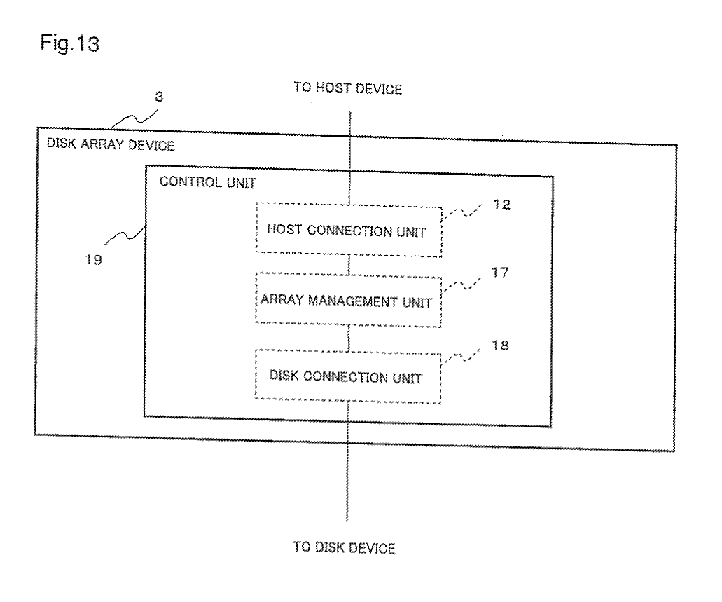

FIG. 13 is a block diagram showing one example of a configuration of disk array device 4 according to the first exemplary embodiment which made the disk unit 20 into different configuration which is not shown. Further, in FIG. 13, same configurations are appended the same numbers as in FIG. 1, and a detailed description will be omitted.

The disk array device 4 makes the history storage unit 31 and the rank unit 32 into different devices. Further, the control unit 19 of the disk array device 4 includes CPU and a memory, and the host connection unit 12, the array management unit 17, and the disk connection unit 18 of the disk array device 3 are made a program processed by the CPU. Therefore, in FIG. 13, the host connection unit 12 and so on is shown by a dotted line.

Thus, even if the disk unit 20 is made into a different device, the disk array device 4 can perform the power saving mode based on the same operation as the disk array device 3 which has already been described.

As has been described above, the disk array device 1 according to the first exemplary embodiment can, even if a disk device of a predetermined rank is stopped in order to reduce electric power consumption, without starting the disk device, obtain the effect such that it can respond to the host device 2 in a predetermined time.

The reason is because the disk array device 1 according to the first exemplary embodiment includes the history storage unit 31 including disk the device 41, and stores write data from the host device 2 in the disk device 41 of the history storage unit 31.

### The Second Exemplary Embodiment

The disk array device 1 according to the first exemplary embodiment performs, when reading data, same read operation as in a reduced state. The reason is because, a rank in a power saving mode is in the same state of a disk device as in a reduced state, in other words, stops a disk device which adds originally redundancy to RAID.

However, in case data is written from the host device 2, and stored in the history storage unit 31, the disk array device 1 can use data stored in the history storage unit 31 also for reading.

In case write data is stored in the history storage unit 31, for a read command from the host device 2, the disk array device 1 according to the second exemplary embodiment responds to the read command using the data stored in the history storage unit 31.

The second exemplary embodiment will be described with reference to drawings.

Further, because a configuration of disk array device 1 according to the second exemplary embodiment is same as the disk array device 1 according to the first exemplary embodiment, a detailed description of the configuration will be omitted.

Also, because operation of the disk array device 1 according to the second exemplary embodiment is the same operation as the disk array device 1 according to the first exemplary embodiment except for read operation in the power saving mode, a detailed description of the same operation will be omitted, and read operation specific to the second exemplary embodiment will be described in detail.

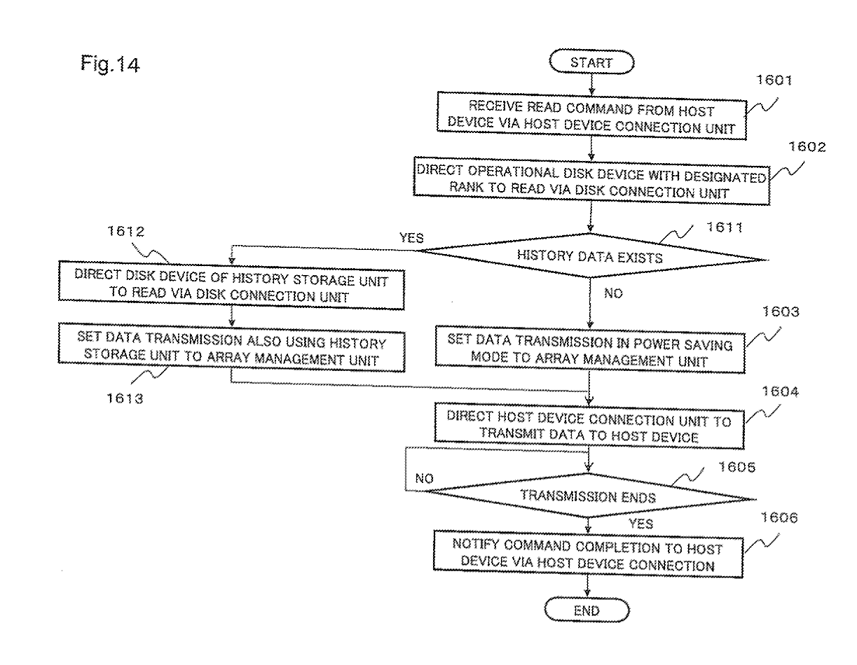

FIG. 14 is a flow chart showing one example of read operation of the disk array device 1 according to the second exemplary embodiment.

In FIG. 14, same operations are appended the same numbers as in FIG. 6, and a detailed description will be omitted.

The processing unit 11 operates same as the processing unit 11 of the first exemplary embodiment until the operation (Step 1602) which directs a disk device of the directed rank and in operation to read.

After that, the processing unit 11 determines whether data designated by a read command is stored in the history storage unit 31 with reference to a stored data table (Step 1611).

In case there is no data in the history storage unit 31 (no in Step 1611), the processing unit 11 performs Step 1603 and after shown in FIG. 6 same as the disk array device 1 according to the first exemplary embodiment.

On the other hand, in case there is data in the history storage unit 31, the processing unit 11 directs the disk device 41 of the history storage unit 31 to read via the disk connection unit 14 (Step 1612). After that, the processing unit 11 directs (Step 1613) the array management unit 13 to synthesize data from the disk device (for example, the disk device 42) of the rank and in operation, and the disk device 41 of the history storage unit 31. Because operation after this is same as the first exemplary embodiment, a detailed description will be omitted.

By performing such operations, the disk array device 1 according to the second exemplary embodiment can realize same read processing as the normal mode in case there is data stored in the history storage unit 31.

The disk array devices 1 according to the second exemplary embodiment can obtain the effect such that it improves reliability of data in addition to the effect according to the first exemplary embodiment.

The reason is because, in case there is data stored in the history storage unit 31, when reading data, the disk array device 1 according to the second exemplary embodiment synthesizes data using the data, and improves reliability of data.

### The Third Exemplary Embodiment

The disk array device 1 according to the first exemplary embodiment writes back data to a rank in case the capacity of the disk device 41 of the history storage unit 31 reaches a predetermined threshold value. However, write back of data is not limited to this.

Disk array device 1 according to the third exemplary embodiment writes back to a rank not only in case the capacity of the disk device 41 of the history storage unit 31 reaches a predetermined threshold value but also, for example, periodically at a predetermined time interval.

Because configuration of the disk array device 1 according to the third exemplary embodiment is same as the disk array device 1 according to the first exemplary embodiment, a description of the configuration will be omitted.

Also, each operation of the disk array device 1 according to the third exemplary embodiment is same except for operation which writes back data to a rank, a detailed description of the same operations will be omitted and the operation specific to the third exemplary embodiment will be described in detail.

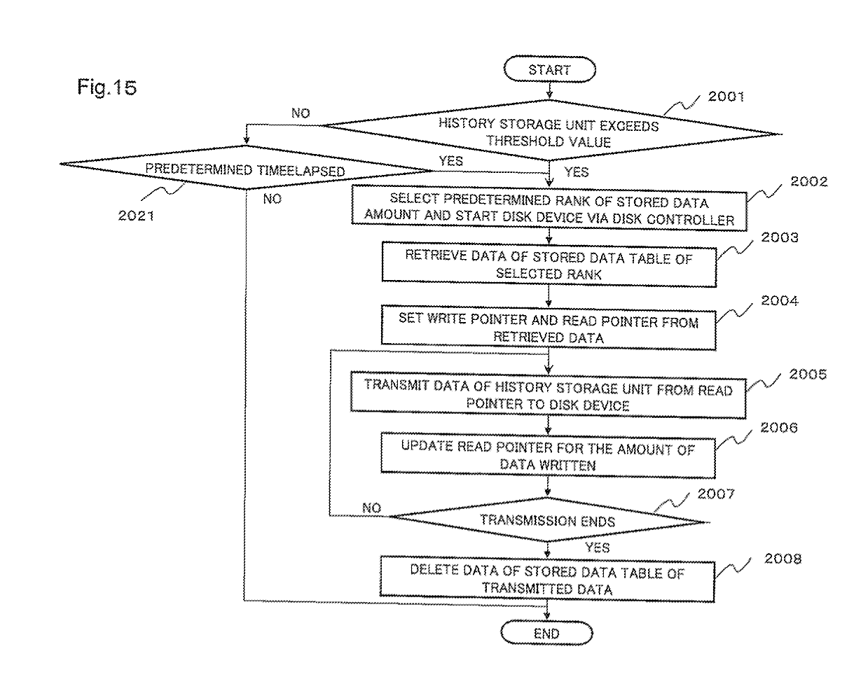

FIG. 15 is a flow chart showing one example of operation in which the disk array device 1 according to the third exemplary embodiment writes back to a rank by own device.

Further, in FIG. 15, same configurations are appended the same number as in FIG. 10, and a detailed description will be omitted.

In case the capacity of the history storage unit 31 does not exceed a predetermined threshold value (no in Step 2001), the processing unit 11 determines whether a predetermined time has elapsed from last write back (Step 2021). It is assumed here that the predetermined time is set in the disk array device 1 in advance.

In case the predetermined time has not elapsed (no in Step 2021), the processing unit 11 ends without processing in particular.

In case the predetermined time has elapsed (yes in Step 2021), the processing unit 11 writes back data to a rank. Because this write back operation is same as the disk array device 1 according to the first exemplary embodiment shown in FIG. 10, a detailed description will be omitted.

Further, although in a description up to here, the processing unit 11 starts to write back to a rank according to a lapse of a predetermined time, the disk array device 1 according to this exemplary embodiment is not limited to this. For example, the processing unit 11 monitors an access state to each rank or an access state to the history storage unit 31, and may write back in case the frequency of the access from the host device 2 is judged to be low and, even if write back is performed, not to influence processing of a command from the host device 2.

The disk array device 1 according to the third exemplary embodiment can obtain the effect such that it reduces the time to write back data of the history storage unit 31 to a rank in addition to the effect according to the first exemplary embodiment.

The reason is because the disk array device 1 according to the third exemplary embodiment writes back data stored in the history storage unit 31 to a corresponding rank at a predetermined time interval or in case access frequency from the host device 2 is low. Therefore, the disk array device 1 according to the third exemplary embodiment can write back before the history storage unit 31 reaches a predetermined threshold value, or in other words, the capacity of stored data in the history storage unit 31 will become large.

According to the present invention, in a disk array device which stops a disk device in order to suppress electric power consumption, the effect that it can respond to a host device without starting the stopped disk device is obtained.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A disk array device comprising:
a control unit which sends and receives a command and data to/from a host device, and, in case a first disk device that constitutes RAID is stopped, controls so that the data which is to be written from said host device to said stopped first disk device is written to a second disk device different from said first disk device.

2. The disk array device according to claim 1, said control unit comprising:
a host connection unit which sends and receives said command and said data to/from said host device;
a disk connection unit which controls said first disk device and said second disk device; and
an array management unit which manages a configuration of a disk device of said first disk device and said second disk device, and in case said first disk device is stopped, controls so that the data which is to be written from said host device to said stopped first disk device is written to said second disk device.

3. The disk array device according to claim 2,
wherein said array management unit directs said disk connection unit to stop said first disk device.

4. The disk array device according to claim 2,
wherein said array management unit writes back the data stored in said second disk device to said first disk device which was stopped in case a capacity of said second disk device exceeded a predetermined threshold value.

5. The disk array device according to claim 2,
wherein said array management unit writes back the data stored in said second disk device to said first disk device which was stopped based on a lapse of a predetermined time.

6. The disk array device according to claim 2,
wherein said array management unit writes back the data stored in said second disk device to said first disk device which was stopped in case access from said host device is less than a predetermined frequency.

7. The disk array device according to either of claims 2,
wherein said array management unit synthesizes data for said host device using the data stored in said second disk device in case the data is stored in said second disk device.

8. A control method of a disk array device, comprising:
sending and receiving a command and data to/from a host device;
controlling a first disk device which constitutes RAID and a second disk device different from the first disk device; and
writing the data which is to be written from said host device to said stopped first disk device to said second disk device in case said first disk device is stopped.

9. The control method of a disk array device according to claim 8, further comprising:
stopping said first disk device in a same stopped state as a reduced state of RAID.

10. A computer readable medium embodying a control program causing a disk array device to perform a method, said method comprising:
processing which sends and receives a command and data to/from a host device;
processing which controls a first disk device which constitutes RAID and a second disk device different from the first disk;
processing which manages a configuration of said first disk device and said second disk device; and
processing which writes the data which is to be written from said host device to said stopped first disk device to said second disk device in case said first disk device is stopped.
